(19) United States
(12) Patent Application Publication
(10) Pub. No.: US 2004/0117515 A1
(43) Pub. Date: Jun. 17, 2004

(54) Distributing system

(76) Inventors: Masuyuki Sago, Tokyo (JP); Masanori Enomoto, Tokyo (JP); Hitoshi Aita, Tokyo (JP); Katsura Sato, Tokyo (JP); Tokiharu Moriyama, Tokyo (JP); Takayuki Oobayashi, Tokyo (JP); Akihide Sasabe, Tokyo (JP)

Correspondence Address: LACKENBACH SIEGEL MARZULLO, ARONSON & GREENSPAN, P.C., Penthouse Suite, One Chase Road, Scarsdale, NY, 10583, US

(21) Appl. No.: 10/713,121

(22) Filed: Nov. 14, 2003

(30) Foreign Application Priority Data
Nov. 15, 2002 (JP) 332040/2002

(51) Int. Cl. G06F 3/00

(52) U.S. Cl. 710/1

(57) ABSTRACT

A distributing system 20, comprising: connection lines 3 to two ends of each of which connector plugs 9 with memory function unit 10 capable of untouchably performing, from the outside thereof, writing-in operation and reading-out operation of identification information of the same connector plugs are respectively connected; plug boards 6 mounted on the distributing system; adapters or receptacles 7, mounted separately on the plug boards and connected respectively to communication lines, for coupling to each of the connector plugs; antennas 11 positioned at the neighborhood of each of the adapters or receptacles for untouchably writing-in operation into and reading-out operation of the address information from the memory function unit when each of the connector plugs is coupled to desired one of the adapters or receptacles; and a data processing and display device 17,18, connected to the antennas, comprising memory means for storing a wiring table indicative of desired mutual relationship between said addresses information of said adapters or receptacles and said identification information of the connector plugs, and display means for displaying desired parts of information on the wiring table. The identification information of each of the connector plugs coupled to one of said adapters or receptacles specified from said mutual relationship is displayed on the display means and stored in the memory means.

### BACKGROUND OF INVENTION

The present invention relates to a distributing system for connecting a line cable or an office cable to patching cords.

There has been proposed a conventional communication system, as shown in FIG. 10A, in which equipments A0 to An are mutually connected to equipments B0 to Bn. In order to change connection wiring between the equipments A0 to An and the equipments B0 to Bn, a distributing system 2 has been employed in which adapters 1a1 to 1an and adapters 1b1 to 1bn are respectively connected to equipments A0 to An and equipments B0 to Bn. In this case, desired change of connection wiring between the equipments A0 to An and the equipments B0 to Bn can be performed by changing-over with patching cords 3₁ to 3ₙ between desired pairs of adapters of a plurality of adapters 1 provided on plug boards 6 in a distributing system 2.

Optical cables and metal cables are employed as communication lines for data communication equipments, while these cables are of single-core type or multi-core type.

In conventional distributing system, a label recorded with letters, symbols or bar codes is appended, on each of connector plugs 4a1 to 4an and 4b1 to 4bn connected to two ends of each of patching cords 3₁ to 3ₙ coupled to adapters on the distributing system 2, to indicate identification information ID of the connector plugs.

Connection operation in the distributing system 2 is carried out by inserting each of the connector plugs 4a1 to 4an and 4b1 to 4bn connected to two ends of each of patching cords 3₁ to 3ₙ to specified one of the adapters 1a1 to 1an and adapters 1b1 to 1bn. Respective ones of the patching cords are connected between each pair of adapters 1a1 to 1an and adapters 1b1 to 1bn indicated on a wiring table, in the same manner as a patching cord 31 is connected between the adapter 1a1 connected to a terminal 01 (not illustrated) of the equipment A0 and the adapter 1b1 connected to a terminal 01 (not illustrated) of the equipment A0.

After connection operation is thoroughly finished, the above mentioned letters, symbols or bar codes appended on the connector plugs 4 connected to two ends of a patching cord 3 are read out in having a look at them or by the use of a bar code reader and then applied to a personal computer (PC) 5 employed as a data processing and display device together with the address information of the instant connector plug 4.

Correct data representative of connection relationship between each of adapters 1a1 to 1an in equipments of one side A and each of adapters 1b1 to 1bn in equipments of another side B are previously stored in the personal computer 5. Therefore, if erroneous insertion of the connector plug 4 in the adapter 1 is detected as a result of comparison operations between connection data of each of the adapters and each of the connector plugs 4, the questioned connection position is indicated on the display plane of the PC 5 so that the questioned connection position can be corrected to a correct connection by changing-over with patching cords connected to the connector plugs 4.

However, the conventional device has such disadvantages that a considerable time is necessary for reading out the address information of the adapter 1 in having a look at them or by the use of a bar code reader, while miss reading and miss input operation may artificially cause in case of reading the address information of the adapter 1 and in case of applying the readout result to the personal computer.

Moreover, since connection operations in the conventional device are carried out to insert each of the connector plugs connected to two ends of the patching cord in view of a connection table indicative of a desired wiring diagram, miss reading of the connection table or miss insertion of the connection plug may cause, while it is difficult to enhance the operation efficiency due to necessity of careful wiring operations.

### SUMMARY OF THE INVENTION

An object of the present invention is to provide a distributing system for enhancing the operation efficiency of wiring connection working by automatically reading out address information of adapters or receptacles and identification information of connector plugs coupled to the adapters or receptacles.

To attain the object and other objects of the present invention, there is proposed a distributing system, comprising:

a plurality of connection lines of single core or multi-core, to two ends of each of which connector plugs with memory function unit capable of untouchably performing, from the outside thereof, writing-in operation and reading-out operation of identification information of the same connector plugs are respectively connected;

a plurality of plug boards mounted on the distributing system;

a plurality of adapters or receptacles, mounted separately on the plug boards and connected respectively to communication lines, for coupling to each of the connector plugs with memory function units capable of untouchably performing, from the outside thereof, writing-in operation and reading-out operation of address information of said adapters or receptacles;

a plurality of antennas positioned at the neighborhood of each of the adapters or receptacles for untouchably writing-in operation into and reading-out operation of the address information from the memory function unit when each of the connector plugs is coupled to desired one of the adapters or receptacles; and

a data processing and display device, connected to a plurality of said antennas, comprising memory means for storing a wiring table indicative of desired mutual relationship between said addresses information of said adapters or receptacles and said identification information of the connector plugs, and display means for displaying desired parts of information pattern on the wiring table;

said identification information of each of the connector plugs coupled to one of said adapters or receptacles specified from said mutual relationship being displayed on the display means and stored in the memory means.

In the distributing system, each of indicators may be mounted at the neighborhood of each of the adapters or the receptacles in order to be ON-OFF switched in accordance with desired switching timing, which is controlled by a control signal from the data processing and displaying device.

The distributing system may further comprises means for lightening the indicators in two different colors of one safe color and the other questioned color, said questioned color being lightened at erroneous connection position in view of said desired mutual relationship between said addresses information of said adapters or receptacles and said identification information of the connector plugs.

### BRIEF DESCRIPTION OF THE DRAWINGS

The present invention will be described in details below with reference to accompanying drawings, in which:

FIG. 1 is a typed view illustrating connection diagram of an embodiment of a distributing system of the present invention;

FIG. 2 is a perspective view illustrating a wiring frame and a plurality of connector adapters employed in the distributing system of the present invention;

FIG. 3 is a perspective view illustrating examples of adapters, a patching cord and a data processing and displaying device employed in the distributing system of the present invention;

FIG. 4A is a perspective view illustrating an example of an adapter employed in the distributing system of the present invention;

FIG. 4B is a perspective view illustrating another example of an adapter employed in the distributing system of the present invention;

FIG. 5A is a typed side view illustrating an adapter and a connector plug employed in the distributing system of the present invention;

FIG. 5B is another typed side view illustrating an adapter and a connector plug employed in the distributing system of the present invention;

FIG. 6 is a flow chart explanatory of an example of operating and processing steps employed in the distributing system of the present invention;

FIG. 7A is a memory map illustrating a collation result in a processing operation in the distributing system of the present invention;

FIG. 7B is a memory map illustrating another collation result in a processing operation in the distributing system of the present invention;

FIG. 8 is a displayed pattern displayed in a processing step in the distributing system of the present invention;

FIG. 9A is a front view illustrating a wiring frame and a plurality of connector adapters employed in another embodiment of the distributing system of the present invention;

FIG. 9B is a typed connection view illustrating a part of the embodiment illustrated in FIG. 9A;

FIG. 10A is a block diagram illustrating a conventional distributing system; and

FIG. 10B is a block connection diagram illustrating a typed conventional distributing system.

### DETAILED DESCRIPTION OF INVENTION

(Embodiment 1)

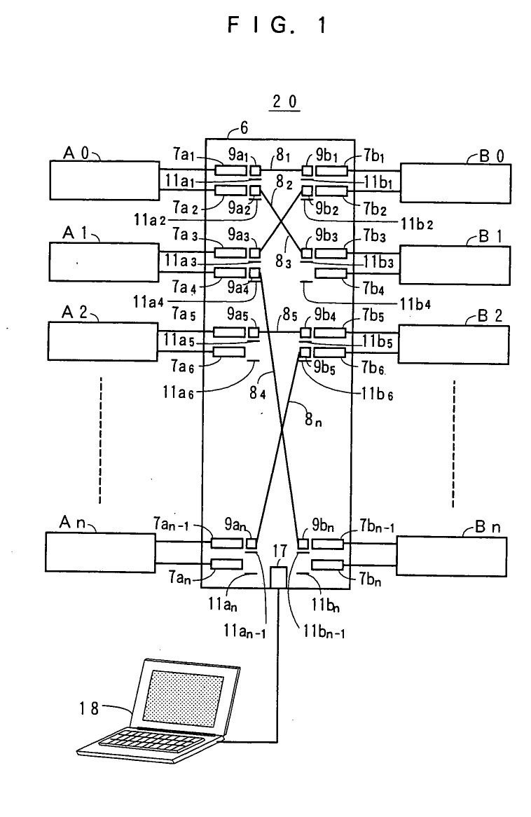

An embodiment of a distributing system 20 of the present invention will be described with reference to FIG. 1, in which connector adapters and connector plugs are employed as optical type by way of example. In a wiring frame 6 for developing the distributing system 20, many optical connection adapters 7a1 to 7an and 7b1 to 7bn are mounted and connected respectively to equipments A0 to An and B0 to Bn. In order to identify respective one of optical connection plugs 9a1 to 9an and 9b1 to 9bn respectively connected to two ends of the patching cord 8₁ to 8ₙ as illustrated in FIG. 3 described later, at the neighborhood of the optical connection adapters 7a1 to 7an and 7b1 to 7bn, there is provided antennas 11a1 to 11an and 11b1 to 11bn each capable of untouchably reading out identification information ID stored in memory function units 10 which mounted respectively on the optical connection plugs 9a1 to 9an and 9b1 to 9bn.

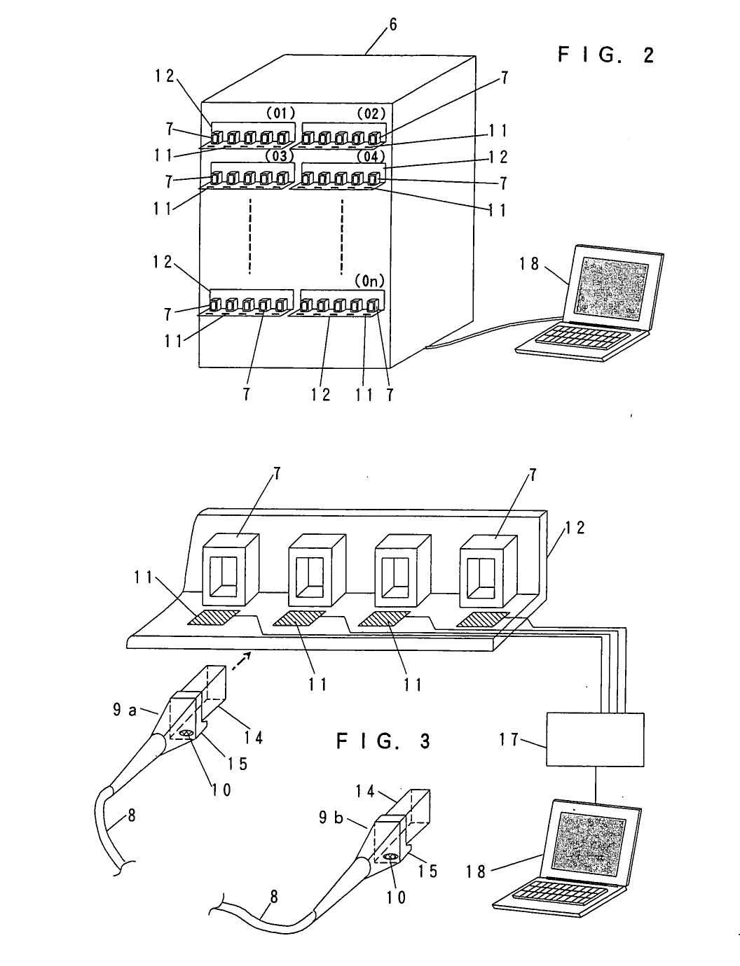

The optical adapters 7 provided on the wiring frame 6 are arranged, as illustrated in FIG. 2, on plug boards (PB) 12 of No. (01) to No. (n), while the antennas 11 are connected to a personal computer 18 through a controller 17 provided in the wiring frame 6.

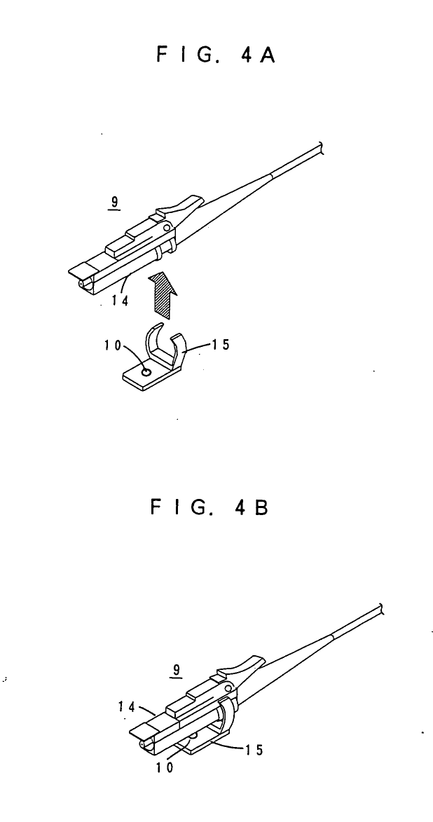

FIG. 3 illustrates a part of one of the plug boards 12 and a part of one of the patching cords 8. In this case, four optical adapters 7 are illustrated on the plug board 12, and the optical connector plugs 9a and 9b each having a memory function unit 10 are respectively connected to one of the patching cords 8. The memory function unit 10 on each of the optical connector plugs 9a and 9b is formed into an outer embeddable format, as illustrated in perspective view in FIG. 4. However, the memory function unit 10 can be fixedly mounted on a body 14 of each optical connector plug 9a or 9b.

The antenna 11 is mounted near the optical adapter 7, so that the memory function unit 10 is positioned just above the antenna 11 capable of untouchably reading out the ID information stored in the memory function unit 10 when the optical connector plug 9a or 9b is insert coupled to the optical adapter 7. The untouchably reading out technique including the memory function unit 10 is formed into an integrated circuit of untouchable type, which has been proposed as an electromagnetic induction system applied to IC cards and IC fixed-term tickets developed as RFID (Radio Frequency Information Distributor) systems.

A plurality of the optical adapters 7 is arranged on the plug board 12 formed into an L-shape in the wiring frame 6, and the antennas 11 are positioned, respectively, at the front portions of the optical adapters 7. Respective ID information symbols designating the respective addresses of the optical adapters 7 on the wiring frame 6 are assigned to all the optical adapters 7, so that each of the addresses is designated by the order number of an instant adapter 7 on a designated one of the plug board 12. These respective addresses of the optical adapters 7 are previously stored in the personal computer (PC) 18 employed as a data processing displaying device.

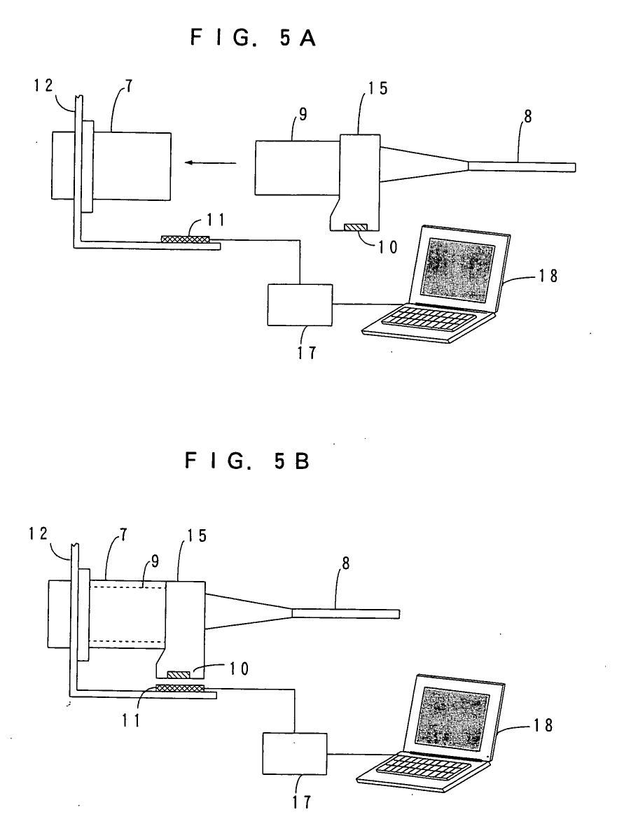

FIG. 5A illustrates a side view of a state preceding from an insertion of the connector plug 9 to the optical adapter 7 arranged on the plug board 12 formed into an L-shape, while FIG. 5B illustrates a side view of an inserted state of the connector plug 9 to the optical adapter 7.

ID information of the memory function units 10 mounted respectively on the optical connector plugs 9a and 9b, which are connected respectively to two ends of the patching cord 8, are usually the same. However, the ID information of the memory function units 10 can be modified to symbols 1a or 1b by way of example.

In a case where the optical connector plugs 9a and 9b connected respectively to two ends of the patching cord 8 are insert coupled to designated ones of the optical adapters 7 in view of a wiring diagram, the ID information of the memory function unit 10 mounted on the optical connector plug 9 insert coupled as mentioned above can be read out by the antenna 11 corresponding to the optical adapter 7 designated from the personal computer 18. This eliminates essential items in conventional techniques for inputting, by an operator, the address data of the optical adapter 7 insert coupled to the connector plug 9a or 9b or the symbol appended on the connector plug 9a or 9b.

In the distributing system of the present invention, the ID information of the optical connector plug 9 can be read out from the personal computer 18 in designating the antenna 11 corresponding to the optical adapter 7 insert coupled to the optical connector plug 9 at each time when the optical connector plug 9 is insert coupled to the optical adapter 7, or the ID information of the optical connector plugs 9 insert coupled, respectively, to the optical adapters 7 can be simultaneously read out in the order designated from the personal computer 18.

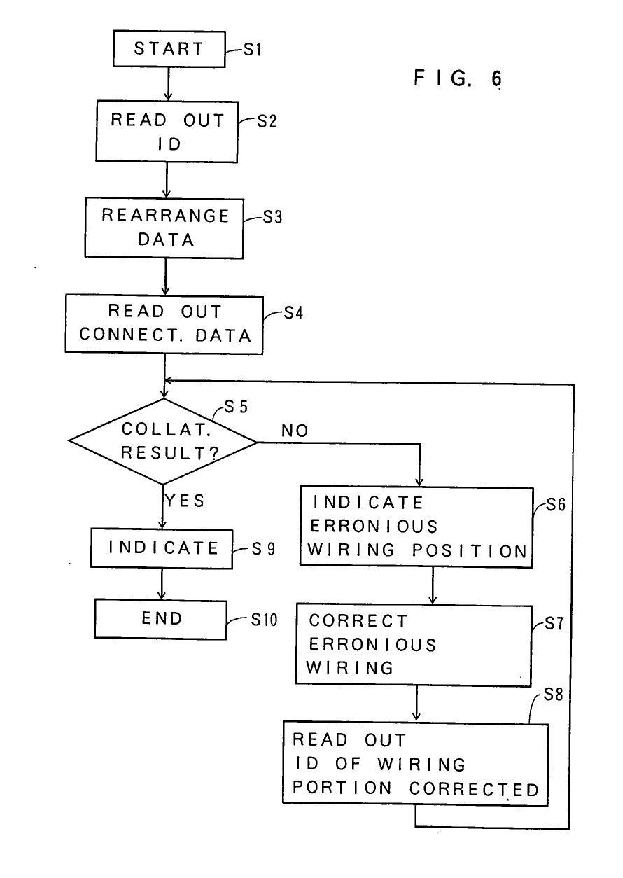

The operations and processing steps in the wiring working of the distributing system of the present invention will now be described with reference to a flow chart illustrated in FIG. 6. At first, the personal computer 18 is started in a step S1. In this starting condition, connection data between communication equipments, that is, the connection data indicative of connection lines between optical adapters 7a1 to 7an connected to the equipments of side A and optical adapters 7b1 to 7bn connected to the equipments of side B are previously stored in the personal computer 18.

In a next step S2, an operator carries out to insert couple the connector plugs 9a and 9b of each patching cord 8 to corresponding optical adapters 7 respectively, and, at each end of the insert coupling operation or the end of the entire insert coupling operations, the ID information of the optical connector plug 9 insert coupled to the optical adapter 7 designated by the personal computer 18 is read out through the antenna 11 and then stored into the address of the instant antenna 11 in an memory of the personal computer 18. In other words, the ID information data stored in the memory function 10 of the optical connector plugs 9a and 9b connected, respectively, to two ends of the patching cord 8 are read out and stored to respective corresponding addresses of the personal computer 18.

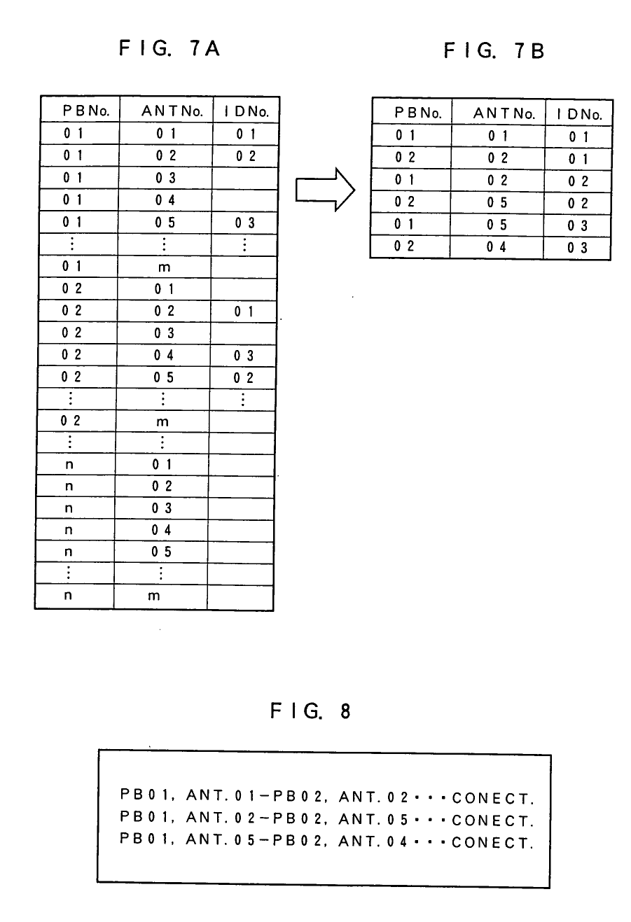

In a step S2, the data read out to the personal computer 18 are reformed into a memory map of connection relationship illustrated FIG. 7A. In other words, this memory map indicates mutual relationships between the ID of the memory function units 10 of each optical connector plug 9 to be coupled to respective ones of the antennas 11 and respective address numbers of the plug boards 12 in the wiring frame 6, and further indicates mutual relationships between the ID of the memory function units 10 of each optical connector plug 9 to be coupled to respective ones of the antennas 11 and respective address numbers of the optical adapters 7. However, the ID of the memory function units 10 of each optical connector plug 9 to be coupled to respective ones of the antennas 11 of the optical adapter 7 are indicated by simple symbols different from that employed in FIG. 1.

In FIG. 1, the groups of 7a and 7b of the optical adapters respectively connected to an equipment group of A0 to An and an equipment group of B0 to Bn are separately illustrated at the right side and the left side. However, actual positions of the groups of 7a and 7b are optionally selectable in consideration of the efficiency of wiring.

In a step S3, the memory map illustrated in FIG. 7A is rearranged as illustrated in FIG. 7B with reference to the ID of the memory function unit 10 of the optical connector plugs 9. In this case, the ID assigned to each pair 9a and 9b of connector plugs respectively connected to two ends of each patching cord 8 indicates that the optical adapter 7 corresponding to the antenna 11 of No.01 on the plug board 12 of No.01 is connected to the optical adapter 7 corresponding to the antenna 11 of No.02 on the plug board 12 of No.02. As a result of the above identification symbols, respective connection addresses of two ends of the patching cord 8 can be confirmed.

In a step 4, instant connection data of communication equipments after changing wiring are read out from connection data (i.e. data of wiring map) of respective communication equipments stored in the personal computer 18.

In a step 5, this instant connection data of communication equipments after changing wiring is collated with the ID data read out from the personal computer 18 in the step S2.

In a step 6, if the above collation operation indicates any erroneous wiring position due to non-coincidence, this erroneous wiring position is indicated on a display plane of the personal computer 18 to correct the erroneous wiring.

The erroneous wiring is corrected in accordance with the above indication on a display of the personal computer 18 (S7), and the ID of the connector plug 9 of the corrected wiring position is read out (S8). When all the insertion coupling of the connector plugs 9 are correctly performed in coincidence states in the step S5, the operation is shifted to a step S9 of indication, in which a data table shown in FIG. 8 is displayed on the display plane of the personal computer 18 in accordance with connection data shown in FIG. 7B. After the step S9, the operation reaches the end (S10).

In the distributing system 20 of the present invention, when an operator inserts, in view of the wiring table, each of the optical connector plugs 9 connected respectively to two ends of the patching cord 8 to a specified one of the optical adapter, ID data of the connector plugs 9 inserted are read out at each insertion time or simultaneously after finishing insertion operations of a necessary number of the connector plugs 9 in order to be able to judge whether each insertion coupling is correct or not. This eliminate necessity in conventional techniques for watching with the eye the insertion state of the connector plugs 9 or for reading out by a bar-cord reader any ID information of the connector plugs 9. Therefore, the distributing system 20 of the present invention has merits that reliability and operation efficiency of wiring operation can be enhanced without erroneous reading out respective connection data or erroneous inputting of respective connection data to the personal computer.

(Embodiment 2)

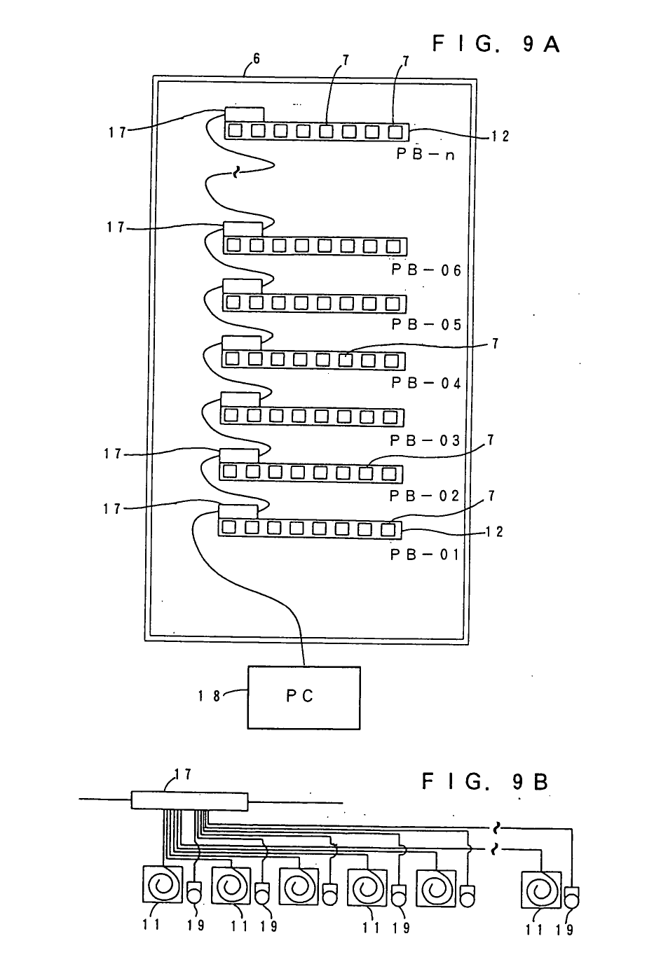

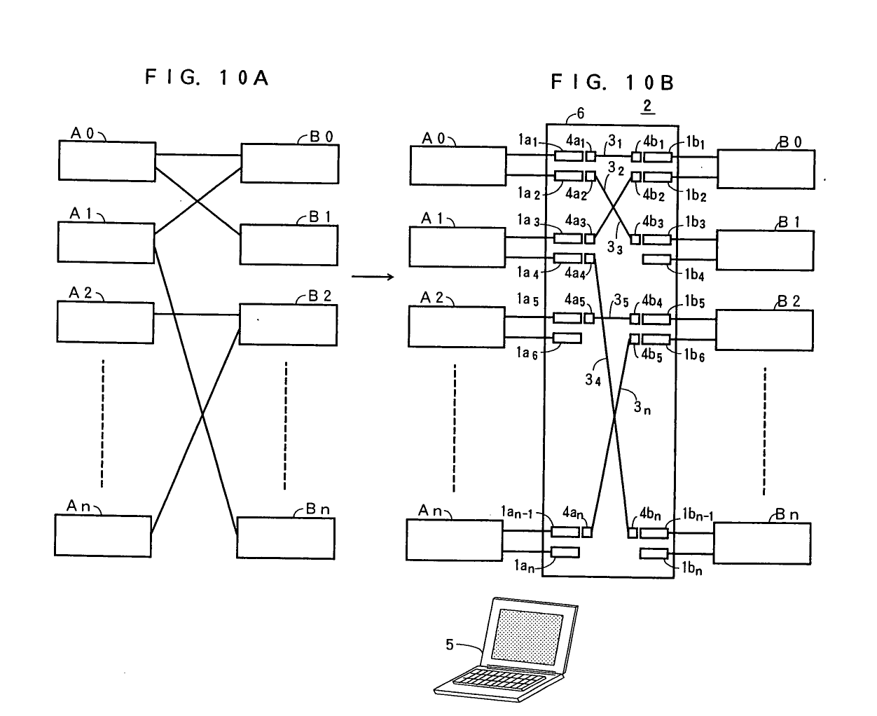

With reference to FIGS. 9A and 9B, another embodiments of the present invention will be described, in which an indicator is provided at the neighborhood of each of the optical connection adapters 7. In this case, FIG. 9A illustrates a front view of the wiring frame 6, and FIG. 9B is a typical view of a part of the plug board 12 provided on the wiring frame 6, on which the antennas 11 and the indicators 19 are mounted in pairs. The indicators 19 are mounted at the lower surface of the plug board 12, by way of example, on the upper surface side of which each optical adapters 7 are mounted, and further connected through each one of controllers 17 to the personal computer 18. In the above construction, the indicators 19 are successively lightened in green color, for example, in accordance with corrected connection data (i.e. wiring map) of communication equipments stored in the personal computer 18 in order to indicate the operator each position of the optical adapter 7, to which each of the optical connector plugs 9 connected respectively to two ends of the patching cord 8 are inserted.

The indicators 19 are ON-OFF switched under control of a control signal, which is read out from the personal computer 18 in a switching timing as mentioned below and held in a corresponding one of the controllers 17. To this end, respective indicators 19 of two optical adapters 7 to be mutually connected are simultaneously lightened to insert respective connector plugs 9 of the patching cord 8 into the two optical adapters 7 lightened. When the two optical adapters 7 are mutually connected by the patching cord 8, the respective indicators 19 of the two optical adapters 7 already connected is switched to the OFF state. Thereafter, respective indicators 19 of two optical adapters 7 to be next mutually connected are simultaneously lightened to guide to insert respective connector plugs 9 of the next patching cord 8 into the two optical adapters 7 lightened. In these operations, each insertion of the optical connection plugs 9 to the optical adapter 7 is detected by the use of the antenna 11 as mentioned previously.

The indicators 19 can be lightened in two different colors of green and red, for example. In this case, if erroneous insertion is detected at the collating operation between the insertion state of the optical connector plug 9 of the patching cord 8 into the optical adapter 7 and corrected connection data (i.e. wiring map) of communication equipments, a necessary control signal indicative of the position of erroneous connection can be sent out from the personal computer 18, so that the questioned optical adapter 7 positioned at the erroneous connection is lightened by a red LED.

Since the embodiment 2 of the present invention is so constructed that the optical adapters 7 to be coupled to the optical connector plugs 9 of the patching cord 8 are successively indicated by the indicators 19, this embodiment 2 of the present invention has merits, such as non-necessity of reading out operation by the operator and enhancement of the operation efficiency and reliability of the connection working.

The above are mainly described with reference to mutual connection between a single core optical connector plug and an optical adapter. However, the present invention can be also applied to mutual connection between a metal connector plug and a metal receptacle, and mutual connection between a multi-core connector plug and an adapter or receptacle.

As mentioned above, the distributing system of the present invention possesses the following characteristic features:

(1) The Connector plugs with memory function units capable of untouchably reading out ID stored therein are connected to two ends of the patching cord, which is employed for connecting between desired two adapters of a plurality of adapters mounted in the distributing system.

(2) Antennas capable of untouchably reading out the ID stored in the memory function units are positioned at the neighborhood of each of the adapters.

(3) When each one of the connector plugs with memory function units is inserted to a desired one of the adapters, connection data relating to the ID of the connector plug connected is automatically applied to a data processing and displaying device to display the connection data processed on the displaying device, thereby enhancing the operation efficiency and reliability of the connection working.

(4) Each of indicators are mounted at the neighborhood of each of the adapters in order to be ON-OFF switched in accordance with desired switching timing, which is controlled by a control signal from the data processing and displaying device. Therefore, connection operation of the connector plugs of a patching cord can be correctly and swiftly performed to effectively enhancing the operation efficiency and reliability of the connection working.

What we claim is:

1. A distributing system, comprising:
a plurality of connection lines of single core or multi-core, to two ends of each of which connector plugs with memory function unit capable of untouchably performing, from the outside thereof, writing-in operation and reading-out operation of identification information of the same connector plugs are respectively connected;
a plurality of plug boards mounted on the distributing system;
a plurality of adapters or receptacles, mounted separately on the plug boards and connected respectively to communication lines, for coupling to each of the connector plugs with memory function units capable of untouchably performing, from the outside thereof, writing-in operation and reading-out operation of address information of said adapters or receptacles;
a plurality of antennas positioned at the neighborhood of each of the adapters or receptacles for untouchably writing-in operation into and reading-out operation of the address information from the memory function unit when each of the connector plugs is coupled to desired one of the adapters or receptacles; and
a data processing and display device, connected to a plurality of said antennas, comprising memory means for storing a wiring table indicative of desired mutual relationship between said addresses information of said adapters or receptacles and said identification information of the connector plugs, and display means for displaying desired parts of information on the wiring table;
said identification information of each of the connector plugs coupled to one of said adapters or receptacles specified from said mutual relationship being displayed on the display means and stored in the memory means.

2. A distributing system according to claim 1, in which each of indicators are mounted at the neighborhood of each of the adapters or the receptacles in order to be ON-OFF switched in accordance with desired switching timing, which is controlled by a control signal from the data processing and displaying device.

3. A distributing system according to claim 2, further comprising means for lightening the indicators in two different colors of one safe color and the other questioned color, said questioned color being lightened at erroneous connection position in view of said desired mutual relationship between said addresses information of said adapters or receptacles and said identification information of the connector plugs.
